(19) United States
(12) Patent Application Publication
(10) Pub. No.: US 2010/0187305 A1
(43) Pub. Date: Jul. 29, 2010

(54) ELECTRONIC TAGGING SYSTEM

(75) Inventor: Edward HOLCOMB, Needham, MA (US)

Correspondence Address: LAHIVE & COCKFIELD, LLP;FLOOR 30, SUITE 3000, ONE POST OFFICE SQUARE, BOSTON, MA, 02109, US

(73) Assignee: VRF HOLDING LLC, Needham, MA (US)

(21) Appl. No.: 12/540,351

(22) Filed: Aug. 12, 2009

Related U.S. Application Data
(60) Provisional application No. 61/088,316, filed on Aug. 12, 2008.

(51) Int. Cl. G06Q 30/00

(52) U.S. Cl. 235/385

(57) ABSTRACT

The present application provides a method and apparatus for electrically tagging footwear and apparel products using easily replaceable power components. The active powered security tag system includes at least two parts. One part includes a power component and electrical and mechanical connection means for connecting to a part that needs a power component. A second part includes an electronic tag including an active electrical component, electronic circuitry, and electrical and mechanical connection means for connecting to a part with a power component. By combining the two parts, an electric circuit is completed so that the power component in one part powers the active electrical component in another part. By separating the power component from the active electrical component, the power component can be easily replaced and the electronic tag can be reused.

### Related Application

This application claims priority to, and claims the benefit of, U.S. provisional patent application Ser. No. 61/088,316, filed on Aug. 12, 2008, the contents of which are hereby incorporated by reference.

### BACKGROUND

1. Field

The present application is directed to a system and method for electronically tagging inventory items, and in particular, to providing a compact and cost-effective device for powering and enabling reuse of active powered tags (APTs) in electronic article surveillance (EAS) systems.

2. Related Art

Inventory items, such as clothing articles, footwear, sporting goods, home and commercial goods, and the like, may be tagged for a number of different reasons. For example, tags may be used to convey price information, size or style information, information regarding promotions, specials, accessories or complementary goods. Tags may also be used to identify and to display to the customer the particular manufacturer, distributor, or retailer of the inventory item, and to provide a way to track and account for the item in a store inventory system. Tags may be a product-level or item-level, unique, machine-readable identifier, such as a barcode or a RFID. Tags such as APTs help identify the theft of an item while concomitantly providing a visual deterrent to item theft.

Tags attached to inventory items may be divided into three broad categories. The tags in the first category may be inactive passive tags and contain no components that interact with the external environment. These tags are typically printed paper, card stock, or cardboard, and are primarily used to convey information. The tags in the second category may be active un-powered tags and contain electronic components that interact with the external environment but do not require an on-board power source, such as a battery. These tags either gather power from outside sources, such as an externally generated electromagnetic field, or they interact with an external source simply by altering an existing and controlled electromagnetic field. The tags in the third category may be active powered tags and contain electronic components that interact with the external environment and include specifically an on-board power source, such as a battery. Tags of this type extend tag functionality in numerous ways—including through active communication with external systems, communication over larger distances, storage and maintenance of information, or the display of dynamic, changeable information.

Active powered tags (APTs) generally consist of a battery or a power subsystem, and a power component that is mechanically and electrically connected with other components or subsystems of the tag. The existence of the connected power component either enables tag functionality, improves tag functionality, or expands tag functionality. According to one example, the tag that includes a short range RFID device has its range dramatically increased by utilizing energy available from an attached power component.

Tags that serve a security function (be they inactive, active unpowered, or APTs) typically are connected to inventory items using a mechanical connection that is intended to be removed only by a retail employee at the time of purchase. Often a push pin type connector is inserted through a part of the inventory item and securely mated with a pin receptacle on the other side of the item. The pin or the pin receptacle may be present on the tag, with the corresponding receptacle or pin being part of a separate backing mechanical structure. Security of the tag attachment to the inventory item is achieved by use of mechanical, electromechanical, or magnetomechanical locking structures at the pin-receptacle interface that require special know how or special equipment to release. Once removed from an inventory item at the point of purchase, these types of tags are intended to be reused. Security tags with a push pin type connector are available from many suppliers, including ADT Security Services of Boca Raton, Fla., which supplies the Sensormatic® Electronic Article Surveillance system and accessories.

Tags that provide optically readable information (text, barcode, etc.) to a customer or retail employee (be they inactive, active unpowered, or APTs) typically are connected to inventory items using a non-secure lanyard type connection. Lanyard connections can be inserted through the inventory item, such as through a buttonhole of the inventory item, or attached directly to the inventory item using a safety pin or similar structure. Lanyards are often made of a thin length of plastic material that has a region at each end that is larger than the region in between and unable to be easily pulled through the attachment point. These types of tags are generally intended to be removed by the customer after purchase and disposed of. The majority of these types of tags are inactive tags without the need for a power component.

### SUMMARY OF THE INVENTION

Recently, advances in display and wireless communications technology have enabled the use of active unpowered tags or APTs for providing optically or machine readable information, such as those disclosed in U.S. Pat. Nos. 6,753,830 and 6,924,781, incorporated herein by reference. Currently available APTs with display capabilities are not, to date, inexpensive enough to be disposed of after use on a single inventory item. In order to be cost effective for a retailer, they may need to be reused on multiple inventory items.

Accordingly, a need exists to extend the reusability of the active powered tags (APTs) by enabling the retailer to easily replace parts that have a shorter life span. There is a need for a more secure mechanical connection between the APT and the inventory item to better ensure their removal at the point of purchase and to reduce their accidental loss or theft.

There is also a need in the art to be able to secure a label to an inventory item with a tag, while concomitantly having the tag provide the power for the label.

It is an object of the present application to provide an active powered security tag system that enables a user to inexpensively and easily replace the required power source.

The present application provides an active powered security tag system having at least two system parts. A first system part includes a power component and/or electrical and mechanical connection means for connecting to a part that needs a power component. A second system part includes a tag or label or other part that provides useful information to the consumer, includes an active electrical component, electronic circuitry, and/or electrical and mechanical connection components for connecting to the first system part having the power component. An example of a suitable second system part is an electronic label that employs electronic ink. By combining the two system parts, an electric circuit is completed so that the power component in one part powers the active electrical component in another part. By separating the power component from the active electrical component, the power component can be easily replaced and the part with the active electrical component can be reused. The parts can be removable and replaceably attached to each other, and hence can be re-used, which provides the retailer handling or selling the inventory items with a highly cost effective solution for tagging inventory items, while concomitantly providing a theft deterrent feature.

The mechanical and electrical connection portions of the above-mentioned parts in the system are arranged so that fitting the parts together creates a mechanical connection to secure the parts together and an electrical connection to complete an electric circuit between the power component and the active electrical component. Thus, the system may include more than two parts that together create a mechanical connection holding all of the parts together and an electric circuit that permits the power source in one part to power at least one active electrical component in at least one other part.

The active electrical component of the tag may include, but is not limited to, displays for conveying machine-readable or human-readable information and light or sound emitters. The information displayed includes, but is not limited to, information useful to the consumer, such as price and discount information, and information useful to the retailer, such as an indicator of remaining battery life.

### BRIEF DESCRIPTION OF THE DRAWINGS

The foregoing and other objects, features and advantages of the invention will be apparent from the following description and apparent from the accompanying drawings, in which like reference characters refer to the same parts throughout the different views. The drawings illustrate principles of the invention and, although not to scale, show relative dimensions.

FIG. 1 is a schematic unassembled depiction of an exemplary active powered security tag system according to the teachings of the present invention.

FIG. 2 is an assembled perspective view of the active powered security tag system showing an active electrical component, such as a tag or label, and a housing component seating a power component according to the teachings of the present invention.

FIG. 3 is a perspective unassembled view of the active powered security tag system shown in FIG. 2 according to the teachings of the present invention.

FIG. 4 is another perspective view of the tag and the housing components of the active powered security tag system shown in FIG. 2.

FIG. 5 depicts an exemplary electronic tag in the active powered security tag system of the present invention.

FIG. 6 depicts an exemplary method for powering a tag component of the active powered security tag system according to the teachings of the present invention.

### DETAILED DESCRIPTION

The present application is directed to systems and methods for the tagging of inventory items with active powered tags consisting of at least two detachable or semi-detachable parts. One part of an active powered security tag system includes at least one power component. Another part of the active powered tag system includes at least one electrical component. When a mechanical connection is made between the parts of the tag system, an electrical connection is also made.

According to one embodiment of the present application, the active powered security tag system has at least two detachable parts consisting of: a first part including optically readable information, a mechanical connection means, an electrical connection means, and at least one node of an electrical circuit (e.g. a single conductive path between two components of the electrical connection means); and a second part including a power component, a mechanical connection means, an electrical connection means, and electric circuitry.

When the first and second parts of the active powered security tag system are connected electrically and mechanically, they form a single usable combined tag structure and the at least one node of an electrical circuit on the first detachable part forms a completed electrical circuit with the electric circuitry on the second detachable part.

One of ordinary skill in the art will readily recognize that a completed electrical circuit is created through the electrical connection of the combined first and second parts. The components can also be used to indicate the state of the electrical and/or mechanical connection between the two parts.

According to an alternative embodiment of the present application, an active powered security tag system has two detachable parts consisting of: a first part including an active electrical component or structure, a mechanical connection means, and an electrical connection means, and a second part including a power component, a mechanical connection means, an electrical connection means, and electric circuitry.

When the first and second parts of the active powered security tag system are connected electrically and mechanically, they form a single usable combined tag structure and the active structure or component in the first part of the combined tag structure receives power from the power component in the second part. The electrical power available to active components on the first part of the active powered security tag system is delivered across the electrical connection means of each part and is available only when the two tag parts are mechanically (and therefore electrically) connected to each other.

An example of this embodiment would be an inventory item tag that includes an optically visible light, such as an LED device, and associated enabling circuitry. The light is the electrically active component present on the first part of the active powered tag system. The power component residing on the second part is a simple battery that is electrically connected to the electrical connection means on that part. When the two parts of the active powered tag system are mechanically and electrically connected, the active component on the first part receives power from the power component on the second part and the light is able to turn on.

The optically readable information can be one or a combination of reflective or light emitting display mediums. Such types of display mediums include, but is not limited to: Electronic ink (E Ink, SiPix), Cholesteric LCD (Kent), L.E.D., O.L.E.D., and L.C.D.

In another embodiment of the invention the components necessary to form the active powered tag system may be distributed across a plurality of detachable parts, such that mechanically and electrically connecting together all of the detachable parts results in a fully functioning active powered security tag system.

A further embodiment of this invention is that in any of the previously described embodiments of an active powered security tag system, at least one of said plurality of detachable parts contains a securing mechanism that allows for the detachable part to be physically attached to an inventory item, such as an article of apparel, or piece of footwear. Examples of some of the types of mechanisms that can be used for attaching a detachable part of an active powered tag system to an inventory item, article of apparel, or piece of footwear include, but are not limited to: a clip, pin, string, strap, and button hook.

A further embodiment of the active powered tag system invention is for the power component to be mounted on a detachable part which contains the mechanism for securing the detachable part to the inventory item. A further embodiment of this invention provides for the power component located on the detachable part to be turned on or off based on whether the securing mechanism of the detachable part is attached to an inventory item. When the detachable part is attached via an attaching mechanism to an inventory item, the power component is active. When it is not attached, the power component is turned off, thereby conserving power and extending the usable life of the power component.

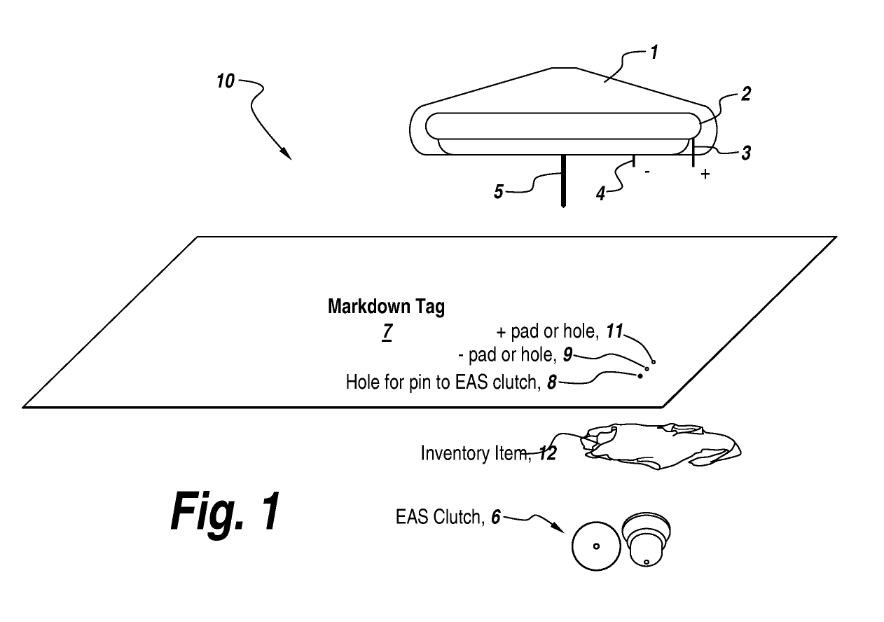

FIG. 1 shows one embodiment of an active powered security tag system 10 comprising a first security housing component 1, a second security housing component 6, and a tag 7. The first security housing component 1 may include a mechanical attaching component 5 for attaching the housing component to an electronic tag or label 7. With the mechanical attaching component 5, the first security housing component 1 is also coupled to an inventory item 12. The second security housing component 6 is configured to be mechanically coupled to the first housing component 1 so that it is difficult to separate the first security housing component 1 from the second security housing component 6 without damaging the inventory item 12, if a special removal tool is not used. The second security housing component 6 may be an electronic article surveillance (EAS) clutch. Examples of mechanical coupling means suitable for use with the present application include those illustrated in U.S. Pat. Nos. 5,077,872 and 7,190,272, the contents of which are incorporated by reference.

The first security housing component 1 according to one embodiment includes a power source component 2. The power source component 2 can be a battery. A positive terminal or connection 3 and a negative terminal or connection 4 extend from the power source component 2 to provide power from the power source component 2. The power source component 2 is separate and distinct from the electronic tag 7 and is electrically coupled thereto for providing power to the electronic tag 7. In another embodiment, the power source component 2 may be enclosed or mounted in a different component that is mechanically and/or electrically coupled to the electronic tag 7. For example, the power source component 2 may be provided in the second security housing component 6, or a component separate from the security housing components 1, 6 and the electronic tag 7.

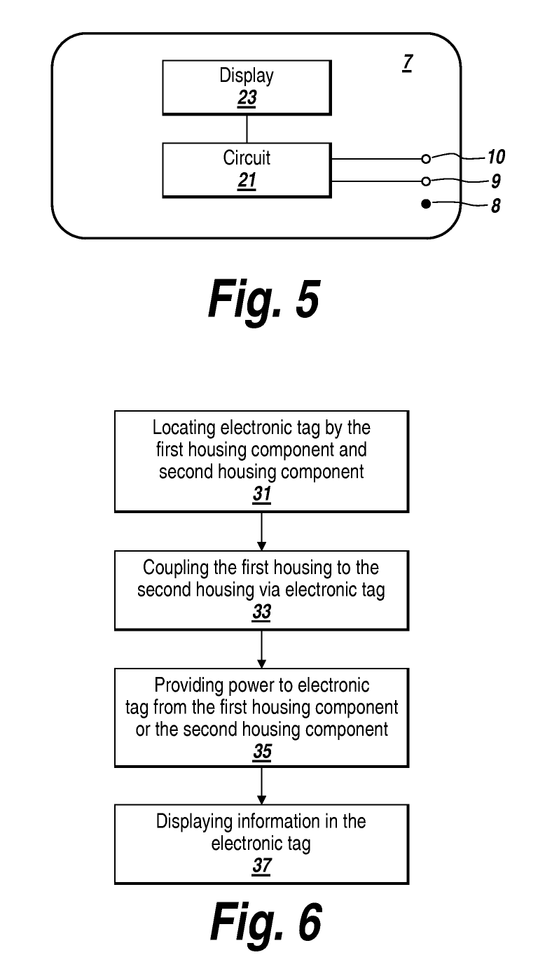

The electronic tag 7 may include a hole 8, a negative pad or hole 9, and a positive pad or hole 10. When the first housing component 1 is coupled to the electronic tag 7, the power source component 2 and electronic tag 7 can be oriented so that the positive electrical terminal 3 electrically contacts the positive pad/hole 10 and the negative electrical terminal 4 electrically contacts the negative pad/hole 9 to complete an electric circuit so that the at least one display 23, FIG. 5, on the electronic tag 7 is powered by the power source component 2 in the first housing component 1. The arrangement of the attaching component 5, the positive electrical terminal 3 and the negative electrical terminal 4 in the first housing component 1 and the corresponding arrangement of the pin hole 8, the positive pad/hole 10, and the negative pad/hole 9 in the electronic tag 7 may differ from the arrangement illustrated without departing from the spirit and scope of the invention.

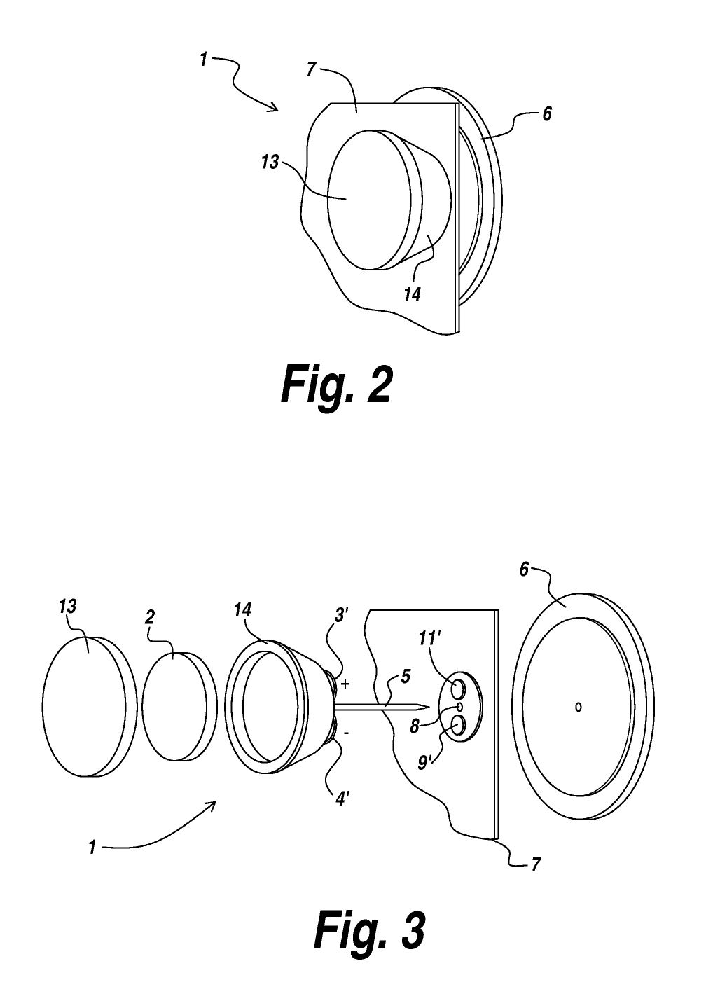

FIG. 2 depicts an illustrative electronic tag combined with housing components in an exemplary embodiment of the present application. In this embodiment, the first housing component 1 includes a top portion 13 and a bottom portion 14. The electronic tag 7 is located between the first housing component 1 and the second housing component 6. Although the inventory item is not show in the Figure, one of ordinary skill in the art will appreciate that the electronic tag 7 is used in connection with the inventory items.

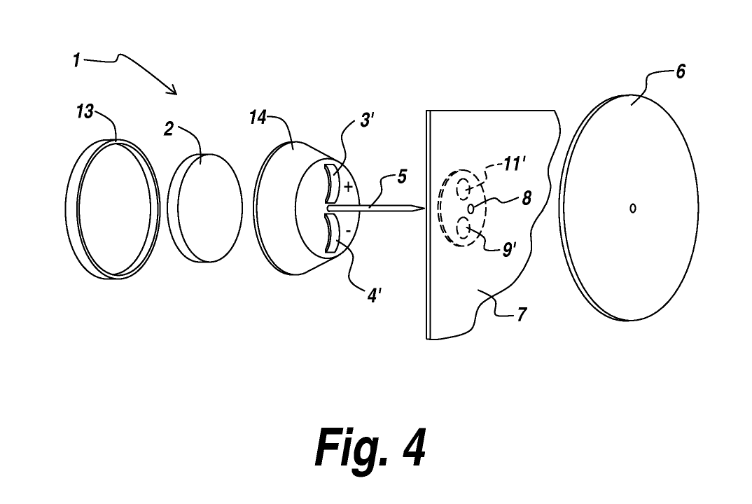

FIGS. 3 and 4 depict perspective views of the tag and the housing components of the active powered security tag system 10, FIG. 2, according to the teachings of the present invention. The power source component 2, according to one embodiment, is contained, housed or seated in a cavity or chamber formed in the first housing component 1. The first housing component 1 includes a positive connection 3′ and a negative connection 4′ connected to the power source component 2 when the power source component 2 is contained in the first housing component 1. The first housing component 1 also includes the mechanical attaching means 5 that is mechanically coupled to the second housing component 6.

The electronic tag 7 includes a hole for the mechanical attaching means 5 to pass through the electronic tag 7. The electronic tag 7 also includes a positive pad 11′ and a negative pad 9′ that contact the positive connection 3′ and the negative connection 4′, respectively, when the housing component 1 is coupled to the second housing component 6. With the connections, power may be provided from the power source component 2 to the electronic tag 7 via the connections 3′ and 4′ and the pads 9′ and 11′.

FIG. 5 depicts an exemplary electronic tag 7 in the active powered security tag system 10 of the present invention. The electronic tag 7 may includes at least one display 23 employing suitable display material, which can include electronic ink, and is coupled to the first housing component 1 and/or the second housing component 6. Examples of tags employing suitable display material and which are suitable for use with the present invention include those illustrated and described in U.S. Pat. Nos. 6,924,781 and 6,753,830, the contents of which are incorporated by reference. Other suitable tags that employ electronic ink can also be used. Those of ordinary skill will readily recognize that the display material preferably employs bi-stable, non-volatile material, such as electronic ink discussed below, so as to reduce the power requirements of the electronic label. Specifically, power does not need to be constantly or periodically provided to the label in order for the display indicia to remain constant and hence stable. This reduces the overall power requirements of the electronic tag, and hence advantageously prolongs the life of the battery provided within one or more of the housing components.

The term “electronic ink” as used herein is intended to include any suitable bi-stable, non-volatile material. The term “bi-stable” as used herein is intended to indicate that the particles of the imaging material can alternately occupy two stable states. For example, the particles corresponding to different pixel locations of the display assembly can alternately occupy an ON or an OFF state to form selected indicia. In an illustrative embodiment, the display media is reflective to provide a greater viewing angle to the image displayed by the electronic label 16. In this case, the particles in the imaging material may be oriented in a first state to reflect light (ON) or a second state to absorb light (OFF). The term “non-volatile” as used herein is intended to denote that the imaging material has indefinite memory without power and will retain an image in the absence of power to the electronic label. The particles in the imaging material maintain a first state unless actively directed to change to a second state. Thus, the imaging surface of the label shows a high-quality image even when power to the label is turned off. The electronic ink can also be a printable, conductive ink having an arrangement of particles or microscopic containers or microcapsules. Each microcapsule has disposed therein an electrophoretic composition of a fluid, such as a dielectric or emulsion fluid, and a suspension of colored or charged particles or colloidal material. The diameter of the microcapsules typically ranges from about 30 to about 300 microns. According to one practice, the particles visually contrast with the dielectric fluid. According to another example, the electronic ink can include rotatable balls that can rotate to expose a different colored surface area, and which can migrate between a forward viewing position and/or a rear non-viewing position, such as gyricon. Specifically, gyricon is a material comprised of twisting rotating elements contained in liquid-filled spherical cavities and embedded in an elastomer medium. The rotating elements can be made to exhibit changes in optical properties by the imposition of an external electric field. Upon application of an electric field of a given polarity, one segment of a rotating element rotates toward, and is visible by an observer of the display. Application of an electric field of opposite polarity, causes the element to rotate and expose a second, different segment to the observer. A gyricon display maintains a given configuration until an electric field is actively applied to the display assembly. Gyricon particles typically have a diameter of about 100 microns. Gyricon materials are disclosed in U.S. Pat. No. 6,147,791, U.S. Pat. No. 4,126,854 and U.S. Pat. No. 6,055,091, the contents of which are herein incorporated by reference.

The term electronic ink can also include a bi-stable non-volatile cholesteric imaging material. The cholesteric liquid crystal material has positive dielectric anisotropy and can include a chiral material in an amount effective to form focal conic and twisted planar textures. Typically cholesteric imaging material comprises liquid crystal cells ranging in thickness from about 25 microns to about 50 microns. Suitable cholesteric materials are disclosed for example in U.S. Pat. No. 6,154,190, U.S. Pat. No. 6,061,107 and U.S. Pat. No. 5,847,798, the contents of which are incorporated herein by reference.

In addition, the electronic ink can include zenithal bi-stable display technology to form the bi-stable nonvolatile display assembly comprised of a bi-stable nematic liquid crystal device cell. The bi-stable nematic cell is provided with a surface alignment grating on at least one cell wall and a surface treatment on an opposite cell wall. The material is activated by dc pulses to form an image. Suitable zenithal bi-stable devices are disclosed in U.S. Pat. No. 6,151,096, world patent application number WO09804953A1, world patent application number WO09934251A1, U.S. Pat. No. 6,054,973, world patent application number WO00052671A1, and U.S. Pat. No. 6,151,096, the contents of which are herein incorporated by reference.

Further, the electronic ink can include a thermo-chromic material. A thermo-chromic material is capable of changing its state alternately between transparent and opaque upon the application of heat. In this manner, a thermo-chromic imaging material develops images through the application of heat at specific pixel locations in order to form an image. The thermo-chromic imaging material retains a particular image until heat is again applied to the material. The display assembly is reusable, rewritable, non-volatile, bi-stable. Visually, black characters are written in a transparent background by applying heat to selected locations or pixels in the display layer. To form color displays other colors, such as red, yellow, and blue are used. Since the rewritable material is transparent, UV fluorescent printings, designs and patterns underneath can be seen through.

The electronic ink can also include surface stabilized ferrroelectric liquid crystals (SSFLC). Surface stabilized ferroelectric liquid crystals confining ferroelectric liquid crystal material between closely-spaced glass plates to suppress the natural helix configuration of the crystals. The cells switch rapidly between two optically distinct, stable states simply by alternating the sign of an applied electric field.

The electronic tag 7 may include an electric circuit 21 for driving the display 23. The electric circuit 21 may include one or more electrical components, such as a processor, visual indicators such as lights or LEDs, sound generators, sensors, receivers, transmitters, transceivers, antennas, back planes, and the like. The electronic circuit 21 may be configured to selectively activate the display 23 to display desired information. An exemplary electronic circuit for driving the display 23 is illustrated in U.S. Pat. Nos. 6,753,830 and 6,924,781, the contents of which are incorporated by reference.

The information displayed on the display 23 can be, according to one embodiment, a subset of the following information.

machine-readable information, such as optically readable information or RFID;

product-level information, such as the price, size, style or brand of the product;

sale or promotion information, such as the percent off the item, or general ongoing or future promotion information;

item-level information, such as a serial number unique to the item;

manufacturer-level information, such as who the manufacturer or distributor is or where the product was made;

inventory loss control information, such as visual deterrents to item theft;

store inventory information, such as how many more of that product is available;

store information, such as the name, address or telephone number of the store; and

battery life information, such as an indicator of the remaining battery life or an indicator that the battery needs to be replaced.

One of ordinary skill in the art will appreciate that the above information is illustrative and the electronic tag 7 may display other information on the display depending on the purpose of the electronic tag.

FIG. 6 depicts an exemplary method for powering a security tag system according to the teachings of the present application. The electronic tag 7 may be located between the first housing component 1 and the second housing component 6 (step 31). The first housing component 1 is coupled to the second housing component 6 via the electronic tag 7 (step 32). In this process, the electronic tag 7 may be attached to the inventory item 12. The first housing component 1 or the second housing component 6 may include a power source component 2 and power is provided to the electronic tag 7 from the first housing component or the second housing component 6. With the power provided from the first housing component 1 or the second housing component 6, the electronic tag 7 may display information on the display 23.

In operation, as noted above, the power component such as the battery is placed within the chamber or cavity formed within the first housing component 14. A second housing component 13 id then secured, and preferably removably and replaceably secured, to the first housing component to forma housing assembly. The housing assembly is coupled to the electronic tag 7 such that the electrical contacts on the bottom of the housing component 14 are disposed in electrical communication and hence in electrical contact with the appropriate portions of the electronic tag, so as to provide power from the battery to the electronic tag. The power from the battery powers the electronic ink display of the electronic tag 7 so as to display selected indicia, such as original price, sale price, percent markdown, manufacturer, and the like. The mechanical element 5 of the housing component 14 is then attached to the inventory item, and is then shielded or mechanically retained within a clutch portion 6.

A significant advantage of the present invention is that by placing the power source component in a housing component separate from the electronic tag, the electronic tag may be used for a longer period of time since the power source component is now easily replaceable, that is, the power source is enclosed in the housing component in a user-replaceable manner. In contrast, if there are any problems with the power source in the currently available APTs, the entire tag must be discarded since there are no user-servicable parts within the APTs. Moreover, since the power source can be placed “off-label” or “off-tag,” the electronic label can be produced in a more cost effective manner while concomitantly providing greater flexibility and ease of use.

Although it is noted that a power source can be provided in a housing of an APT for eventual electrical connection to the electronic label, this does not preclude the use of an additional battery provided in the electronic tag 7. One can be provided if desired for use as a redundant power source.

While the present application is described in terms of one or more preferred embodiments, it should be understood that any Active Powered Tag used in an EAS system is contemplated for use with this invention.

We claim:

1. An active powered security tag system attachable to an inventory item for displaying indicia, the tag system comprising:
a first housing component attachable to the inventory item;
a second housing component configured to be mechanically coupled to the first housing component;
an electronic tag having a display employing electronic ink and being coupled to the first or second housing components; and
a power source separate and distinct from the electronic tag and coupled thereto for providing power to power the display.

2. The security tag system of claim 1, wherein the power source is housed within the first housing component or the second housing component.

3. The security tag system of claim 1, wherein the first housing component or the second housing component comprises a cavity formed therein and the power source is disposed within the cavity.

4. The security tag system of claim 1, wherein the first housing component or the second housing component comprises terminals extending from the power source for providing power from the power source.

5. The security tag system of claim 4, wherein the electronic tag comprises pads connected to the terminals to receive power from the power source.

6. The security tag system of claim 4, wherein the electronic tag comprises holes for receiving the terminals to receive power from the power source.

7. The security tag system of claim 1, wherein the first housing component or the second housing component comprises an electronic article surveillance (EAS) clutch.

8. The security tag system of claim 1, wherein the electronic tag comprises a driving circuit for driving the display.

9. A method for displaying indicia in an active powered security tag system attachable to a inventory item, the method comprising:
locating an electronic tag between a first housing component and a second housing component;
coupling the first housing component 1 to the second housing component via the electronic tag;
providing power to the electronic tag from the first housing component or the second housing component; and
displaying predetermined information on a display of the electronic tag using the power.

10. The method of claim 9, further comprising:
attaching the electronic tag to a inventory item.

11. The method of claim 9, wherein the first housing component or the second housing component comprises a power source component.

12. The method of claim 9, wherein the electronic tag comprises a driving circuit for displaying the information on the display.

13. The method of claim 9, wherein the electronic tag displays machine-readable information.

14. The method of claim 13, wherein the machine-readable information comprises optically readable information or RFID.

15. The method of claim 9, wherein the electronic tag displays information on a power source component in the first housing component or the second housing component.
